(19) United States
(12) Patent Application Publication
(10) Pub. No.: US 2011/0116189 A1
(43) Pub. Date: May 19, 2011

(54) MAGNETIC RECORDING MEDIUM AND MAGNETIC RECORDING/REPRODUCING DEVICE

(75) Inventor: Yuzo Sasaki, Ichihara-shi (JP)

(73) Assignee: SHOWA DENKO K.K., Minato-ku, Tokyo (JP)

(21) Appl. No.: 12/675,036

(22) PCT Filed: Sep. 2, 2008
(86) PCT No.: PCT/JP2008/065743

§ 371 Date: Feb. 24, 2010

(30) Foreign Application Priority Data
Sep. 5, 2007 (JP) 2007-230564

(51) Int. Cl. G11B 5/127; G11B 5/66

(52) U.S. Cl. 360/110; 428/800; 428/831; G9B/5.04; G9B/5.241

(57) ABSTRACT

The present invention relates to a perpendicular magnetic recording medium including at least a backing layer, an orientation control layer, a magnetic recording layer and a protective layer provided on top of a non-magnetic substrate, wherein the orientation control layer is composed of two or more layers including a seed layer and an intermediate layer, formed in that order from the substrate side, and the seed layer is formed of a material containing 5 to 25 atomic % of an element for which, in a phase diagram, the solid solution region with an element having a face-centered cubic structure is not more than 1 atomic %. Also provided is a magnetic recording/reproducing device that includes the magnetic recording medium and a magnetic head for recording and reproducing information on the magnetic recording medium.

### TECHNICAL FIELD

The present invention relates to a magnetic recording medium and a magnetic recording/reproducing device that uses the magnetic recording medium.

### BACKGROUND ART

In recent years, the range of applications for magnetic recording devices such as magnetic disk devices, flexible disk devices and magnetic tape devices has expanded enormously, and not only has the importance of such devices increased, but the recording density of the magnetic recording media used in these devices has continued to increase markedly. Since the introduction of MR heads and PRML techniques, the increase in areal recording densities has become even more dramatic, and the more recent introduction of GMR heads and TuMR heads and the like has meant that recording densities continue to increase at a pace of 30 to 40% per year.

In this manner, there are strong demands for even higher recording densities for magnetic recording media, and meeting these demands requires further improvements in the coercive force and signal to noise ratio (SNR) of the magnetic recording layer, and higher levels of resolution. In longitudinal magnetic recording systems, which have been widely used until now, as the linear recording density is increased, a self-demagnetizing effect that causes adjacent recording domains of a magnetization transition region to undergo a mutual weakening of magnetization tends to become dominant. Accordingly, in order to avoid this problem, it has been necessary to make the magnetic recording layer progressively thinner, thereby increasing the shape magnetic anisotropy.

On the other hand, as the thickness of the magnetic recording layer is reduced, the size of the energy barrier required to retain the magnetic domain and the size of the thermal energy approach the same level, meaning the phenomenon wherein the amount of recorded magnetization is moderated due to the effects of temperature (the thermal fluctuation phenomenon) can no longer be ignored, and it is believed that the limit for linear recording density is determined by these types of factors.

Against this background, the use of AFC (Anti Ferromagnetic Coupling) media has recently been proposed as a technique for satisfying the demands for further improvements in the linear recording density of longitudinal magnetic recording systems, and strenuous efforts are being made to avoid the problem of thermal magnetic relaxation, which tends to be a problem in longitudinal magnetic recording.

One powerful technique that is garnering much attention for its potential to enable further future increases in areal recording density is the perpendicular magnetic recording technique. In conventional longitudinal magnetic recording systems, the medium is magnetized in the in-plane direction, whereas in perpendicular magnetic recording systems, the medium is magnetized in a direction perpendicular to the medium surface. As a result, it is thought that the self-demagnetizing effect that represents an obstacle to achieving higher recording densities in longitudinal magnetic recording systems can be effectively avoided, making such perpendicular magnetic recording systems ideal for high density recording. Further, it is also thought that because a certain magnetic layer thickness can be maintained, the effect of thermal magnetic relaxation, which is a significant problem in longitudinal magnetic recording, should be comparatively small.

A perpendicular magnetic recording medium is typically prepared by sequentially depositing a seed layer, an intermediate layer, a magnetic recording layer and an overcoat on top of a non-magnetic substrate. Further, following film deposition through to the protective layer, a lubricant layer is often applied to the surface of the medium. Furthermore, in many cases, a magnetic film known as a soft-magnetic under layer (SUL) is provided beneath the seed layer. The intermediate layer is formed for the purpose of further enhancing the properties of the magnetic recording layer. The seed layer controls the crystal orientation of the intermediate layer and the magnetic recording layer, and is said to also have the function of controlling the shape of the magnetic grains.

In order to produce a perpendicular magnetic recording medium having superior properties, improving the crystal orientation of the magnetic recording layer and reducing the crystal grain size are important factors. In many perpendicular magnetic recording media, a Co alloy material is used as the magnetic recording layer, and the crystal structure adopts a hexagonal close-packed structure. It is important that the (002) crystal plane of the hexagonal close-packed structure is parallel to the substrate surface. In other words, it is important that the crystal c-axis ([002] axis) is aligned along the perpendicular direction with as little disorder as possible.

In order to form the magnetic recording layer crystals with minimal disorder, Ru has frequently been used as the intermediate layer for the perpendicular magnetic recording medium as it adopts the same hexagonal close-packed structure as conventional magnetic recording layers. Crystals of the magnetic recording layer undergo epitaxial growth on the Ru (002) crystal plane, meaning a magnetic recording medium having favorable crystal orientation can be obtained (for example, see Patent Document 1).

In other words, because improving the degree of orientation of the (002) crystal plane of the Ru intermediate layer also improves the orientation of the magnetic recording layer, improving the recording density of the perpendicular magnetic recording medium requires an improvement in the Ru (002) crystal plane orientation properties. However, if the Ru is deposited directly on top of the amorphous SUL, then an overly thick Ru film is required to obtain superior crystal orientation, meaning during recording, the non-magnetic Ru weakens the pull of the flux from the head to SUL. Accordingly, conventionally a seed layer oriented in the (111) crystal plane of a face-centered cubic structure has been inserted between the SUL and the Ru intermediate layer (for example, see Patent Document 2). The seed layer having a face-centered cubic structure yields a high degree of crystal orientation even with a thin film of approximately 3 (nm), and a Ru layer formed on top of the face-centered cubic structure of the seed layer has a high degree of crystal orientation even if the layer is thinner than a Ru layer deposited directly on top of the amorphous SUL.

Moreover, one technique that is essential for improving the recording density is reduction in the size of the crystal grains of the magnetic recording layer. Patent Document 2 discloses a magnetic recording medium in which an intermediate layer having a three-layer structure is provided between the soft magnetic layer and the magnetic recording layer in order to reduce the crystal grain size of the magnetic recording layer, wherein a metal or the like having a hexagonal close-packed structure is used as the first intermediate layer, a metal or the like having a face-centered cubic structure is used as the second intermediate layer, and Ru or a Ru alloy is used as the third intermediate layer. Furthermore, the document also discloses the use of Al, Ag, Au, Cu, Ni and Pd and the like as the second intermediate layer. Moreover, in Patent Document 3, W that adopts a body-centered cubic structure is added to Ni that adopts a face-centered cubic structure under conditions within the solid solution region, thereby reducing the magnetic crystal grain size on a seed layer having a face-centered cubic structure. However, in order to achieve further improvements in the recording density, additional reductions in the crystal grain size are required, but if the amount of added W is increased, then when W>15 atomic %, the mixture falls outside the solid solution region and the Ni—W alloy is no longer able to retain a face-centered cubic structure, meaning orientation of the Ru of the intermediate layer and the magnetic recording layer degrades.

Achieving further improvements in the recording and reproduction properties requires a perpendicular magnetic recording medium having excellent recording and reproduction properties, which enables a further reduction in the crystal grain size for the magnetic crystal grains, while also maintaining favorable crystal orientation properties. A perpendicular magnetic recording medium that is able to resolve the above issues and is also able to be produced easily has been keenly sought.
[Patent Document 1]
Japanese Unexamined Patent Application, First Publication No. 2001-6158
[Patent Document 2]
Japanese Unexamined Patent Application, First Publication No. 2005-190517
[Patent Document 3]
Japanese Unexamined Patent Application, First Publication No. 2007-179598

### DISCLOSURE OF INVENTION

### Problems to be Solved by the Invention

The present invention takes the above circumstances into consideration, with an object of providing a magnetic recording medium which, by reducing the crystal grain size for the magnetic crystal grains while retaining favorable perpendicular orientation properties for the magnetic recording layer, is capable of recording and reproducing information at a high density, as well as providing a method for producing such a magnetic recording medium and a magnetic recording/reproducing device.

### Means to Solve the Problems

In order to achieve the above object, the present invention adopts the aspects described below.

(1) A perpendicular magnetic recording medium including at least a backing layer, an orientation control layer, a magnetic recording layer and a protective layer provided on top of a non-magnetic substrate, wherein the orientation control layer is composed of two or more layers including a seed layer and an intermediate layer, formed in that order from the substrate side, and the seed layer is formed of a material containing 5 to 25 atomic % of an element for which, in a phase diagram, the solid solution region with an element having a face-centered cubic structure is not more than 1 atomic %.
(2) The magnetic recording medium according to (1) above, wherein the element having a face-centered cubic structure is one element selected from the group consisting of Cu, Ag and Au, and the seed layer contains not less than 30 atomic % of this element.
(3) The magnetic recording medium according to (1) or (2) above, wherein the element for which the solid solution region in a phase diagram is not more than 1 atomic % is an element having a body-centered cubic structure.
(4) The magnetic recording medium according to any one of (1) to (3) above, wherein the element for which the solid solution region in a phase diagram is not more than 1 atomic % is one element selected from the group consisting of V, Nb, Ta, Cr, Mo and W.
(5) The magnetic recording medium according to any one of (1) to (4) above, wherein the thickness of the seed layer is within a range from 3 to 12 nm.
(6) The magnetic recording medium according to any one of (1) to (5) above, wherein at least one layer of the intermediate layer is formed from Ru, Re or an alloy material thereof, and has a hexagonal close-packed structure.
(7) The magnetic recording medium according to any one of (1) to (6) above, wherein at least one layer of the magnetic recording layer adopts a granular structure composed of ferromagnetic crystal grains and crystal grain boundaries of a non-magnetic oxide.
(8) The magnetic recording medium according to any one of (1) to (7) above, wherein the average crystal grain size of the magnetic recording layer is within a range from 1 to 7 nm.
(9) A magnetic recording/reproducing device including a magnetic recording medium and a magnetic head for recording and reproducing information on the magnetic recording medium, wherein the magnetic recording medium is a magnetic recording medium according to any one of (1) to (8) above.

### Effect of the Invention

The present invention is able to provide a perpendicular magnetic recording medium having superior high recording density properties, in which the crystal structure of the magnetic recording layer, and particularly the crystal c-axis of a hexagonal close-packed structure, is oriented with minimal angular dispersion relative to the substrate plane, and in which the average grain size of the crystal grains that constitute the magnetic recording layer is extremely small.

### BRIEF DESCRIPTION OF THE DRAWINGS

FIG. 1 is a diagram illustrating the cross-sectional structure of a perpendicular magnetic recording medium according to the present invention.

FIG. 2 is a diagram illustrating the structure of a perpendicular magnetic recording/reproducing device according to the present invention.

FIG. 3 is a binary phase diagram for Ni—W.

FIG. 4 is a binary phase diagram for Cu—W.

FIG. 5 is a binary phase diagram for Au—W.

### DESCRIPTION OF THE REFERENCE SYMBOLS

1 Non-magnetic substrate
2 Soft magnetic backing layer
3 Seed layer
4 First intermediate layer
5 Second intermediate layer
6 Magnetic recording layer
7 Protective layer
100 Magnetic recording medium
101 Medium drive unit
102 Magnetic head
103 Head drive unit
104 Recording/reproducing signal system

### BEST MODE FOR CARRYING OUT THE INVENTION

Specifics relating to the content of the present invention are presented below.

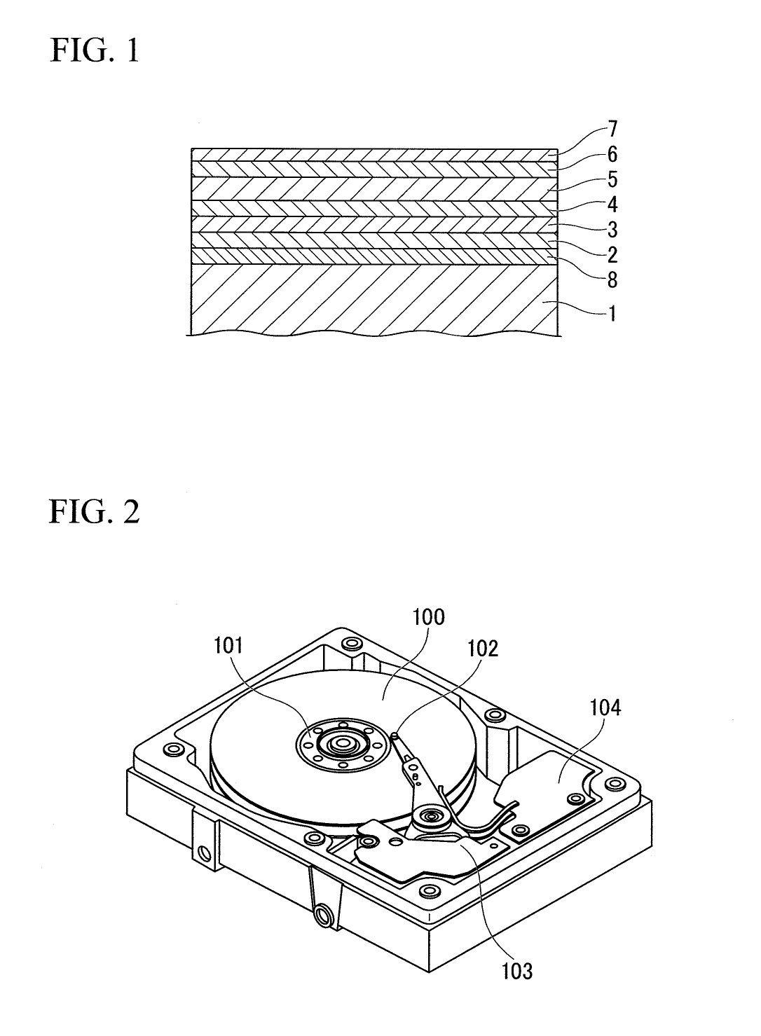

As illustrated in FIG. 1, a perpendicular magnetic recording medium 100 of the present invention includes at least a soft magnetic backing layer 2, an orientation control layer which is composed of a seed layer 3 and a first intermediate layer 4 and controls the orientation of a film formed directly thereon, a second intermediate layer 5, a magnetic recording layer 6 in which the axis of easy magnetization (the crystal c-axis) is oriented substantially perpendicularly to the plane of the substrate, and a protective layer 7 formed on a non-magnetic substrate 1, wherein the orientation control layer is composed of a plurality of layers. These types of orientation control layers are expected to provide further improvements in the recording density, and can also be applied to ECC media and new perpendicular magnetic recording media such as discrete track media and patterned media.

The non-magnetic substrate used in the magnetic recording medium of the present invention may employ any non-magnetic substrate, including substrates formed from Al alloys containing Al as the main constituent such as Al—Mg alloys, conventional soda glass, aluminosilicate glass, amorphous glass, silicon, titanium, ceramics, sapphire, quartz, or any of a variety of resins. Of these, the use of an Al alloy substrate or a glass substrate of a crystallized glass or amorphous glass is preferred. In the case of a glass substrate, mirror-polished substrates and low Ra substrates in which Ra<1 (Å) are particularly desirable. The substrate may be textured, provided the degree of texturing is light.

In a production process for a magnetic disk, the substrate is usually first cleaned and dried. This also applies in the present invention, and from the viewpoint of ensuring favorable adhesion of each of the layers, it is preferable that the cleaning and drying of the substrate is performed prior to the formation of the layers. The term “cleaning” includes not only washing with water, but also cleaning performed using etching (reverse sputtering). There are no particular limitations on the substrate size.

Next is a description of each of the layers of the perpendicular magnetic recording medium.

A soft magnetic backing layer is provided in many perpendicular magnetic recording media. When a signal is recorded on the medium, the soft magnetic backing layer has the function of guiding the recording magnetic field from the head, and efficiently applying the perpendicular component of the magnetic field to the magnetic recording layer. The material for the soft magnetic backing layer may use any material having so-called soft magnetic properties, such as a FeCo-based alloy, CoZrNb-based alloy or CoTaZr-based alloy. The soft magnetic backing layer preferably has an amorphous structure. By employing an amorphous structure, increases in the surface roughness (Ra) can be prevented, and the head floating height can be reduced, enabling a further increase in the recording density. Moreover, in addition to the soft magnetic single layers mentioned above, structures in which an extremely thin non-magnetic film of Ru or the like is sandwiched between two layers, thereby causing AFC between the two soft magnetic layers, are also frequently used. The overall thickness of the backing layer is typically within a range from approximately 20 (nm) to 120 (nm), with the actual thickness determined on the basis of achieving a favorable balance between the recording and reproduction properties and the OW properties.

In the present invention, an orientation control layer that controls the orientation of the film provided immediately thereon is provided on top of the soft magnetic backing layer. The orientation control layer is composed of a plurality of layers termed the seed layer and the intermediate layer, with the seed layer disposed on the substrate side of the structure.

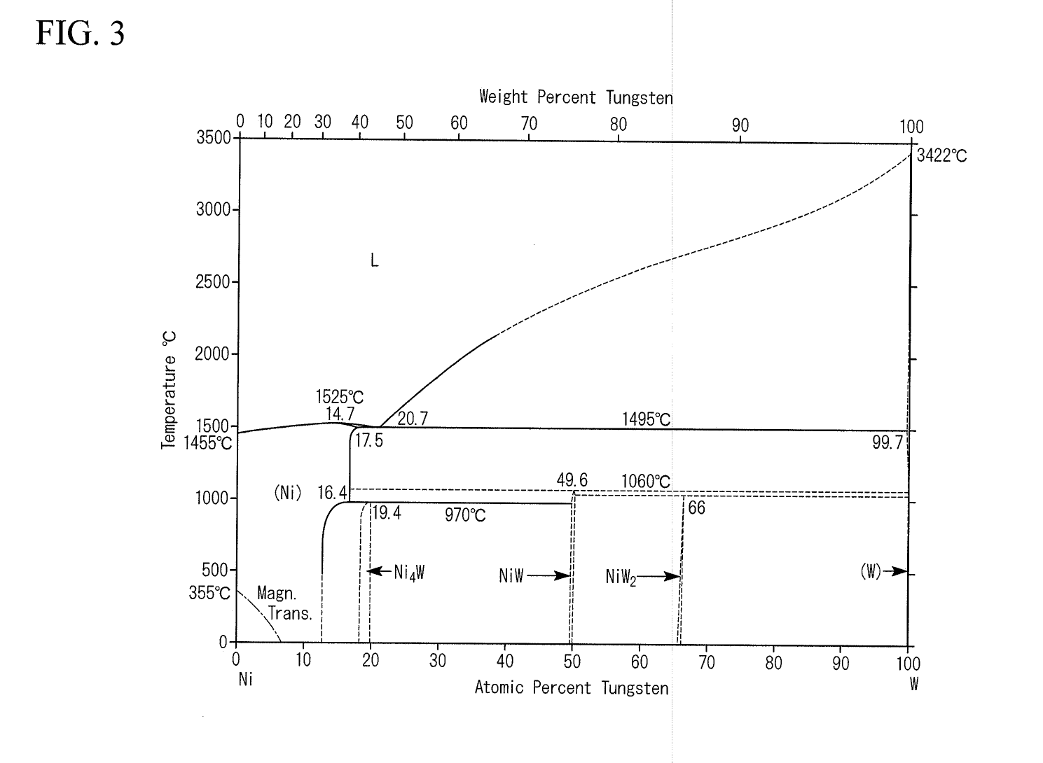

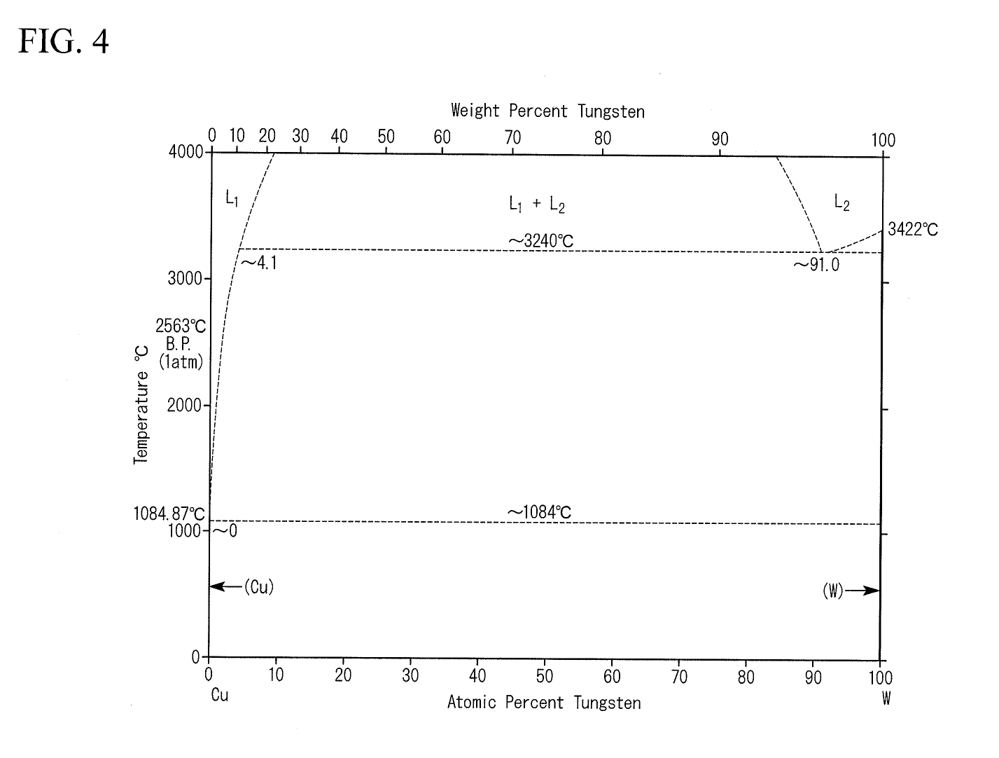

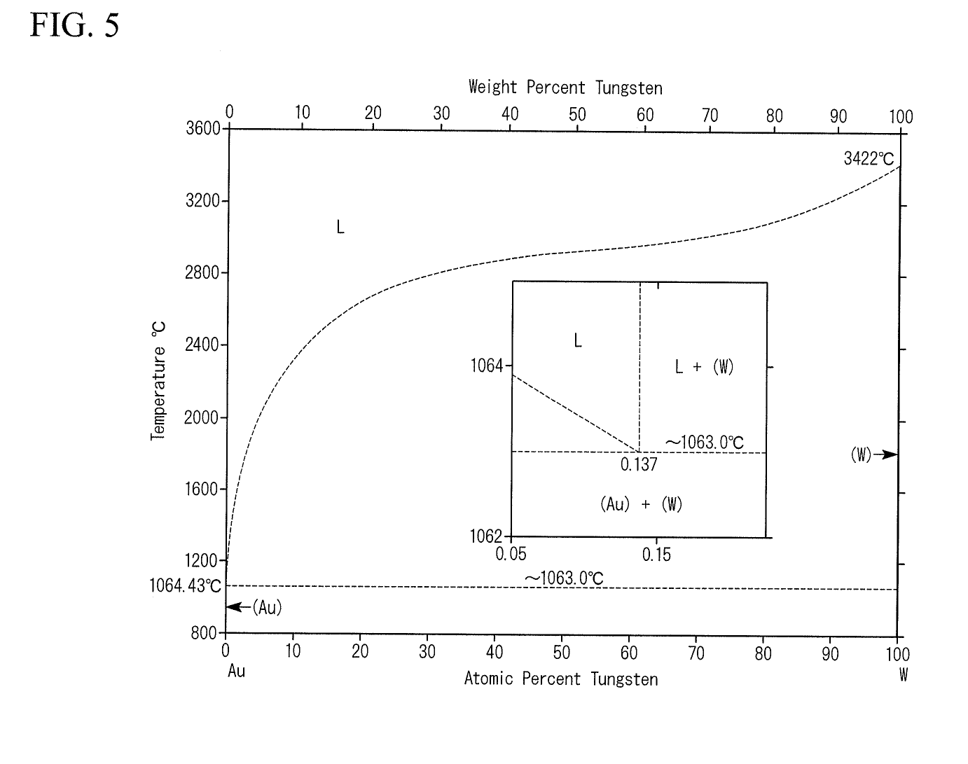

In the present invention, by reducing the crystal grain size of a seed layer having a face-centered cubic structure, a reduction in the average crystal grain size of the intermediate layer to not more than 7 (nm) can be achieved. Here, the average crystal grain size is determined by inspecting the crystalline shape of the layer using a transmission electron microscope (TEM) or the like, measuring the diameter of those crystal grains that can be clearly distinguished, and then statistically processing the plurality of diameter values to determine an average value. The technique used for reducing the crystal grain size of the seed layer involves adding not less than 5 atomic % and not more than 25 atomic % of an element for which, in a phase diagram, the solid solution region with an element having a face-centered cubic structure is not more than 1 atomic %. Here, the “solid solution region” describes a region within a binary phase diagram for an element having a face-centered cubic structure and an added element, and refers to the region of the face-centered cubic structure phase when the amount of the added element is 0 atomic %. Usually, if the added element does not adopt a face-centered cubic structure, then once the amount of the added element exceeds a certain amount, either a different crystal structure is adopted, or an intermediate region composed of a face-centered cubic structure and a different crystal structure is formed. FIG. 3 to FIG. 5 illustrate binary phase diagrams for Ni—W, Cu—W and Au—W respectively. Ni, Cu and Au all have face-centered cubic structures, whereas W has a body-centered cubic structure. As illustrated in FIG. 3, Ni has a solid solution region relative to W amounts of not more than approximately 15 atomic %, whereas in the Cu—W phase diagram illustrated in FIG. 4, there is almost no solid solution region for W within Cu, and the W amount is not more than 1 atomic %. Similarly, in the Au—W phase diagram illustrated in FIG. 5, the solid solution region for W within Au is not more than 1 atomic %.

The element having a face-centered cubic structure that is used for the seed layer in the present invention preferably employs an element having a melting point of not less than 800° C., as such elements are preferred in terms of reducing the crystal grain size of the seed layer.

In the present invention, an amount of the added element outside of the solid solution region is added to the element having a face-centered cubic structure. However in the case of an element for which the solid solution region is several atomic % or more, the base element and the added element will jointly generate a crystal lattice that maintains the face-centered cubic crystal structure for amounts of the added element within the solid solution region, but outside of the solid solution region, this crystal structure can no longer be maintained, resulting in a deterioration in the orientation of the intermediate layer and the magnetic recording layer, and a concomitant deterioration in the recording and reproduction properties. In contrast, in the case of an element for which the solid solution region is not more than 1 atomic %, even if an amount of only several atomic % is added, the added element is not incorporated within the face-centered cubic structure, but is rather segregated between crystals of the face-centered cubic structure composed of the base element, or exists in voids within the crystal lattice of the face-centered cubic structure. Accordingly, provided the amount of the added element is not more than a certain value, it has almost no effect on the crystal structure of the face-centered cubic structure, but rather only controls the crystal grain size.

The element that adopts the face-centered cubic structure of the present invention is preferably Cu, Ag or Au. Ni, which is widely used as the material for conventional seed layers tends to have a broad solid solution region with other elements. In other words, when another element is added, the Ni tends to incorporate the other element within the crystal lattice, meaning it is not particularly desirable for achieving a crystal grain size reduction by addition of the other element in an amount outside the solid solution region. In the present invention, the added element is preferably an element that has a body-centered cubic structure. Specific examples include elements such as V, Nb, Ta Cr, Mo and W. Because the crystal orientation properties of the magnetic recording layer laminated on top of the intermediate layer are determined substantially by the crystal orientation of the intermediate layer, controlling the orientation of the intermediate layer is an extremely important factor in producing the perpendicular magnetic recording medium. In order to improve the orientation of the fine intermediate layer crystals epitaxially grown on top of the seed layer, the gas pressure during deposition of the initial growth portion of the intermediate layer is preferably low. However, if the crystal growth is continued with the gas pressure in a low state, then crystal grains of the intermediate layer are more likely to undergo coalescence during the crystal growth process. The crystal grains of the magnetic recording layer formed on top of such coalesced crystals of the intermediate layer undergo epitaxial growth as single crystals, meaning a problem arises in that the crystal grain size of the magnetic recording layer increases to substantially the crystal grain size of the coalesced crystal grains within the intermediate layer.

As a result, in the present invention, at least two intermediate layers are provided, with a first intermediate layer and a second intermediate layer formed in that order from the side of the substrate. In order to improve the crystal orientation properties of the intermediate layer, the first intermediate layer of the present invention is deposited at a low gas pressure, and is preferably deposited at a pressure of not more than 1 (Pa). Furthermore, in order to improve the crystal orientation and suppress coalescence of the crystal grains, the film thickness of the first intermediate layer is preferably not less than 1 (nm) but not more than 15 (nm), and more preferably not less than 5 (nm) but not more than 10 (nm).

The magnetic recording layer is epitaxially grown on top of the second intermediate layer of the present invention, and therefore the second intermediate layer adopts a hexagonal close-packed structure or face-centered cubic structure. Further, because coalescence of adjacent crystal grains can be suppressed by generating voids between the crystal grains by performing the deposition under a higher pressure, the deposition gas pressure during deposition of the second intermediate layer is preferably at least 1.5 (Pa), and more preferably 3 (Pa) or higher. Furthermore, if the crystal grains are surrounded by grain boundaries composed of an oxide or nitride, then not only can coalescence of the crystal grains be inhibited, but by thickening the width of the grain boundaries, the size of the crystal grains can be further reduced. In the present invention, by suppressing coalescence of the crystal grains within the intermediate layer, a single crystal grain of the magnetic recording layer is epitaxially grown on each single crystal grain of the intermediate layer.

In the present invention, the first and second intermediate layers may be laminated as thin films of Ru, Re or an alloy thereof, and at least one of the intermediate layers is preferably oriented in the (002) crystal plane of a hexagonal close-packed structure. In many perpendicular magnetic recording media, the crystal structure of the magnetic recording layer adopts a hexagonal close-packed structure, and it is important that the (002) crystal plane of that structure is parallel to the substrate plane. In other words, it is important that the crystal c-axis ([002] axis) is aligned along the perpendicular direction with as little disorder as possible. The full width at half maximum of a rocking curve can be used as a method of evaluating the crystal structure. Firstly, the deposited film on the substrate is set in an X-ray diffraction apparatus, and the crystal plane parallel to the substrate surface is analyzed. In those cases where the sample being evaluated includes films that adopt a hexagonal close-packed structure such as the intermediate layer and magnetic recording layer described above, the diffraction peaks corresponding with these crystal planes are observed. In the case of a perpendicular magnetic recording medium that uses a Co-based alloy, because the c-axis ([002]) direction of the hexagonal close-packed structure is oriented perpendicularly relative to the substrate surface, a peak that corresponds with the (002) plane is observed. Subsequently, the optical system is swung relative to the substrate surface while the Bragg angle causing the diffraction of the (002) plane is maintained. By plotting the (002) crystal plane diffraction intensity against the inclination angle of the optical system, a single diffraction peak can be drawn. This plot is called a rocking curve. When the (002) crystal plane is aligned in an extremely favorable parallel relationship with the substrate surface, a rocking curve with a very sharp peak is obtained, whereas in those cases where the alignment of the (002) crystal plane is dispersed broadly, a broad rocking curve is obtained. Accordingly, the full width at half maximum Åθ50 for the rocking curve can be used as an indicator of the quality of the crystal orientation of the perpendicular magnetic recording medium.

The present invention enables a perpendicular magnetic recording medium having a small Δθ50 value to be produced with relative ease.

As the name suggests, the magnetic recording layer is the layer on which a signal is actually recorded. The material for the magnetic recording layer is frequently a thin film of a Co-based alloy such as CoCr, CoCrPt, CoCrPtB, CoCrPtB—X, CoCrPtB—X—Y, CoCrPt—O, CoCrPtRu—O, CoCrPt—SiO₂, CoCrPt—Cr₂O₃, CoCrPt—TiO₂, CoCrPt—ZrO₂, CoCrPt—Nb₂O₅, CoCrPt—Ta₂O₅, CoCrPt—B₂O₃, CoCrPt—WO₂, CoCrPt—WO₃ and CoCrPt—RuO₂. In the above materials, X and Y represent Ti, Cu, Mo, W, Ta or Mg. Particularly in those cases where an oxide magnetic layer is used, by employing a structure in which the oxide forms a granular structure that surrounds the magnetic Co crystal grains, the magnetic interaction between the Co crystal grains can be weakened and the level of noise can be reduced. The crystal structure and magnetic properties of the magnetic recording layer ultimately determine the recording and reproduction properties.

A DC magnetron sputtering method or RF sputtering method is typically used for deposition of each of the layers described above. An RF bias, DC bias, pulsed DC, pulsed DC bias, O₂ gas, H₂O gas, H₂ gas or N₂ gas may also be used. The sputtering gas pressure during deposition is preferably determined so as to optimize the properties of each layer, but is typically controlled within a range from approximately 0.1 to 30 (Pa), and is adjusted in accordance with the performance of the medium.

The protective layer is provided to protect the medium from damage caused by contact between the magnetic head and the medium. Examples of the protective layer include a carbon film or SiO₂ film or the like, although a carbon film is the most common. The protective layer can be formed using a method such as a sputtering method or plasma CVD method, and in recent years, a plasma CVD method is most commonly used. A magnetron plasma CVD method may also be used. The thickness of the protective layer is preferably within a range from 1 to 10 (nm), more preferably from 2 to 6 (nm), and still more preferably from 2 to 4 (nm).

FIG. 2 illustrates one example of a perpendicular magnetic recording/reproducing device that uses the perpendicular magnetic recording medium described above. The magnetic recording/reproducing device illustrated in FIG. 2 includes a perpendicular magnetic recording medium 100 having the structure illustrated in FIG. 1, a medium drive unit 101 that rotates the perpendicular magnetic recording medium 100, a magnetic head 102 that records or reproduces information on the perpendicular magnetic recording medium 100, a head drive unit 103 that moves the magnetic head 102 relative to the perpendicular magnetic recording medium 100, and a recording/reproducing signal processing system 104.

The recording/reproducing signal processing system 104 can process data input from externally and transmit this data as recording signals to the magnetic head 102, as well as processing reproduction signals from the magnetic head 102 and transmitting the resulting data externally.

The magnetic head 12 used in the magnetic recording/reproducing device of the present invention may use any of the magnetic heads that are suitable for higher recording densities, including heads that employs, as the reproduction element, a MR (Magneto Resistance) element that uses an anisotropic magneto resistance effect (AMR), a GMR (giant magneto resistance) element that uses a GMR effect, or a TuMR element that uses a tunneling effect.

### EXAMPLES

Specific details of the present invention are described below based on a series of examples.

### Example 1, Comparative Example 1

A vacuum chamber with HD glass substrates set inside was evacuated down to a pressure of not more than 1.0×10⁻⁵ (Pa).

Subsequently, using a sputtering method, a soft magnetic backing layer of Co10Ta5Zr with a thickness of 50 (nm) was deposited on each substrate under an Ar atmosphere at a gas pressure of 0.6 (Pa).

Next, a seed layer of Cu10Cr, Cu20Cr, Cu10V, Cu20V, Cu10W, Cu20W, Ag10V, Ag20V, Au10W or Au20W (atomic %) with a thickness of 5 (nm), and then a first intermediate layer of Ru with a thickness of 8 (nm) were deposited sequentially on each substrate under an Ar atmosphere at a gas pressure of 0.6 (Pa) (examples 1-1 to 1-10). A second intermediate layer of Ru with a thickness of 12 (nm) was then deposited on each substrate under an Ar atmosphere at a gas pressure of 5 (Pa). In comparative examples, seed layers of Cu, Cu30Cr, Cu30V, Cu30W, Ag, Ag30V, Au and Au30W with a thickness of 5 (nm) were deposited under an Ar atmosphere at a gas pressure of 0.6 (Pa) (comparative examples 1-1 to 1-8). A first intermediate layer and second intermediate layer were then deposited under the same conditions as those used for the examples.

A magnetic recording layer of 91(Co19Cr19Pt)-9(SiO₂) (mol %) and a protective layer composed of a C film were then deposited, thus completing production of a series of perpendicular magnetic recording media.

A lubricant was applied to each of the obtained perpendicular magnetic recording media (example 1-10, and comparative examples 1-1 to 1-8) and the recording and reproduction properties were evaluated using a Read/Write Analyzer 1632 and a Spin Stand S1701MP manufactured by Guzik Technical Enterprises, USA. Subsequently, the static magnetic properties were evaluated using a Kerr measuring apparatus. Furthermore, in order to examine the crystal orientation of the Co-based alloy of the magnetic recording layer, a rocking curve for the magnetic layer was measured using an X-ray diffractometer.

Based on the results of the above measurements, the signal to noise ratio (SNR), the coercive force (Hc) and the value of delta θ50 for each of the examples and comparative examples are listed in Table 1. Each of these parameters is an indicator frequently used for evaluating the performance of perpendicular magnetic recording media.

From Table 1 it is evident that when the amount of the added element in the seed layer was 10 or 20 (atomic %), favorable orientation properties and a favorable SNR were obtained for the magnetic recording layer. On the other hand, in the case of the seed layers containing no added element, although the crystal orientation properties were not poor, the SNR value was considerably lower than the values obtained for the examples. It is thought that this reflects the fact that because the seed layer contained no added element, the grain size was not able to be controlled. Further, in the case of the seed layers containing 30 (atomic %) of the added element, the crystal orientation properties had deteriorated, meaning the SNR values were 1 (dB) or more lower than the values obtained for the examples.

### Example 2, Comparative Example 2

Soft magnetic layers were deposited on glass substrates in the same manner as example 1. A seed layer of Cu10V, Cu20V, Cu10W or Cu20W with a thickness of 8 (nm) was then deposited under an Ar atmosphere at a gas pressure of 0.6 (Pa) (examples 2-1 to 2-4). As comparative examples, a seed layer of Ni, Ni10V, Ni20V, Ni30V, Ni10W, Ni20W or Ni30W with a thickness of 8 (nm) was deposited under an Ar atmosphere at a gas pressure of 0.6 (Pa) (comparative examples 2-1 to 2-7).

Subsequently, a first intermediate layer of Ru with a thickness of 10 (nm) and a second intermediate layer of Ru-2TiO₂ (mol %) with a thickness of 10 (nm) were deposited under an Ar atmosphere at gas pressures of 0.6 (Pa) and 10 (Pa) respectively. A magnetic recording layer of 91(Co19Cr19Pt)-9(SiO₂) (mol %) and a protective layer composed of a C film were then deposited, thus completing production of a series of perpendicular magnetic recording media.

For each of the examples and comparative examples, Guzik measurements were used to determine the signal to noise ratio (SNR) and the overwrite capability (OW), Kerr measurements were used to determine the coercive force (Hc), and X-ray diffraction measurements were used to determine the delta θ50 value. Moreover, using a planar TEM image of each magnetic recording layer, crystal grain size measurements were performed for the Co-based alloy of the magnetic recording layer. The results of the above measurements are listed in Table 2.

From Table 2 it is evident that when V or W was added to crystals of Ni having a face-centered cubic structure, the crystal orientation properties deteriorated, although the average crystal grain size of the magnetic recording layer was reduced. The deterioration in the orientation caused by the added element was extreme, and therefore even though the grain size was reduced, the SNR value peaked at 10 (atomic %) of the added element, and deteriorated as the amount of the added element was increased beyond that level.

### Example 3

Soft magnetic layers were deposited on glass substrates in the same manner as example 1. A seed layer of Cu10Nb or Cu10Mo with a thickness of 8 (nm) was then deposited under an Ar atmosphere at a gas pressure of 0.6 (Pa) (examples 3-1 and 3-2). As comparative examples, a seed layer of Cu10Ni, Cu110Pt, Cu10Mn or Cu10Mg with a thickness of 8 (nm) was deposited under an Ar atmosphere at a gas pressure of 0.6 (Pa) (comparative examples 3-1 to 3-4).

Subsequently, in the same manner as example 2, a first intermediate layer of Ru with a thickness of 10 (nm) and a second intermediate layer of Ru-2TiO₂ (mol %) with a thickness of 10 (nm) were deposited under an Ar atmosphere at gas pressures of 0.6 (Pa) and 10 (Pa) respectively. A magnetic recording layer of 91(Co19Cr19Pt)-9(SiO₂) (mol %) and a protective layer composed of a C film were then deposited to complete the perpendicular magnetic recording media.

Table 3 lists the results for the SNR, Hc and delta θ50 values determined for each of these examples and comparative examples.

From Table 3 it is clear that when an element for which the solid solution region with Cu is at least 1 atomic % was added to Cu in an amount of 10 (atomic %), the crystal orientation properties of the magnetic recording layer deteriorated, and the SNR value was also at least 1 (dB) lower than that obtained when an element for which the solid solution region is less than 1 atomic % was added.

TABLE 1

| | Seed layer | | | | Delta |
|---|---|---|---|---|---|
| | (atomic | Thickness | SNR | Hc | θ50 |
| Sample | %) | (nm) | (dB) | (Oe) | (deg.) |
| Example 1-1 | Cu10Cr | 5 | 17.45 | 4201 | 3.0 |
| Example 1-2 | Cu20Cr | | 17.65 | 4176 | 2.9 |
| Example 1-3 | Cu10V | | 17.72 | 4079 | 2.9 |
| Example 1-4 | Cu20V | | 17.80 | 4035 | 2.9 |
| Example 1-5 | Cu10W | | 17.53 | 4092 | 2.8 |
| Example 1-6 | Cu20W | | 17.59 | 4024 | 2.7 |
| Example 1-7 | Ag10V | | 17.34 | 4282 | 2.8 |
| Example 1-8 | Ag20V | | 17.33 | 4216 | 2.8 |
| Example 1-9 | Au10W | | 17.79 | 4329 | 2.6 |
| Example 1-10 | Au20W | | 18.02 | 4287 | 2.5 |
| Comparative example 1-1 | Cu | 5 | 16.74 | 3873 | 3.6 |
| Comparative example 1-2 | Cu30Cr | | 15.62 | 3568 | 4.8 |
| Comparative example 1-3 | Cu30V | | 15.35 | 3451 | 5.1 |
| Comparative example 1-4 | Cu30W | | 15.18 | 3420 | 5.3 |
| Comparative example 1-5 | Ag | | 16.85 | 3892 | 3.3 |
| Comparative example 1-6 | Ag30V | | 15.44 | 3382 | 5.3 |
| Comparative example 1-7 | Au | | 16.91 | 3925 | 3.1 |
| Comparative example 1-8 | Au30W | | 15.89 | 3637 | 4.9 |

TABLE 2

| | | Thick- | | | Average | Delta |
|---|---|---|---|---|---|---|
| | Seed layer | ness | SNR | Hc | grain | θ50 |
| Sample | (atomic %) | (nm) | (dB) | (Oe) | size (nm) | (deg.) |
| Example 2-1 | Cu10V | 8 | 18.46 | 4201 | 5.6 | 2.5 |
| Example 2-2 | Cu20V | | 18.63 | 4183 | 5.5 | 2.4 |
| Example 2-3 | Cu10W | | 18.49 | 4104 | 5.6 | 2.3 |
| Example 2-4 | Cu20W | | 18.35 | 4066 | 5.8 | 2.5 |
| Comparative | Ni | 8 | 16.79 | 4829 | 10.4 | 2.5 |
| example 2-1 | | | | | | |
| Comparative | Ni10V | | 17.52 | 4522 | 8.2 | 2.8 |
| example 2-2 | | | | | | |
| Comparative | Ni20V | | 17.23 | 4278 | 7.6 | 3.5 |
| example 2-3 | | | | | | |
| Comparative | Ni30V | | 16.72 | 3737 | 7.2 | 7.3 |
| example 2-4 | | | | | | |
| Comparative | Ni10W | | 17.58 | 4439 | 8.0 | 2.8 |
| example 2-5 | | | | | | |
| Comparative | Ni20W | | 16.56 | 3820 | 7.4 | 4.6 |
| example 2-6 | | | | | | |
| Comparative | Ni30W | | 16.03 | 3351 | 7.0 | 8.4 |
| example 2-7 | | | | | | |

TABLE 3

| | | | Solid solution | | | |
|---|---|---|---|---|---|---|
| | Seed layer | Thickness | region for element | SNR | Hc | Delta θ50 |
| Sample | (atomic %) | (nm) | added to Cu | (dB) | (Oe) | (deg.) |
| Example 3-1 | Cu10Nb | 8 | less than 1% | 18.24 | 4305 | 2.6 |
| Example 3-2 | Cu10Mo | | less than 1% | 18.33 | 4278 | 2.5 |
| Comparative | Cu10Ni | | 100% | 16.78 | 3921 | 4.0 |
| example 3-1 | | | | | | |
| Comparative | Cu10Pt | 8 | 100% | 17.03 | 3984 | 3.9 |
| example 3-2 | | | | | | |
| Comparative | Cu10Mn | | 100% | 16.34 | 3574 | 5.1 |
| example 3-3 | | | | | | |
| Comparative | Cu10Mg | | 7% | 16.04 | 3479 | 5.8 |
| example 3-4 | | | | | | |

### INDUSTRIAL APPLICABILITY

The magnetic recording medium of the present invention and a magnetic recording/reproducing device that uses the magnetic recording medium can be used in the field of information technology, and has a high level of industrial applicability.

1. A perpendicular magnetic recording medium, comprising at least a backing layer, an orientation control layer, a magnetic recording layer and a protective layer provided on top of a non-magnetic substrate, wherein said orientation control layer comprises two or more layers including a seed layer and an intermediate layer, formed in that order from a side of said substrate, and said seed layer is formed of a material comprising 5 to 25 atomic % of an element for which, in a phase diagram, a solid solution region with an element having a face-centered cubic structure is not more than 1 atomic %.

2. The magnetic recording medium according to claim 1, wherein said element having a face-centered cubic structure is one element selected from the group consisting of Cu, Ag and Au, and said seed layer comprises not less than 30 atomic % of this element.

3. The magnetic recording medium according to claim 1, wherein said element for which a solid solution region in a phase diagram is not more than 1 atomic % is an element having a body-centered cubic structure.

4. The magnetic recording medium according to claim 1, wherein said element for which a solid solution region in a phase diagram is not more than 1 atomic % is one element selected from the group consisting of V, Nb, Ta, Cr, Mo and W.

5. The magnetic recording medium according to claim 1, wherein a thickness of said seed layer is within a range from 3 to 12 nm.

6. The magnetic recording medium according to claim 1, wherein at least one layer of said intermediate layer is formed from Ru, Re or an alloy material thereof, and has a hexagonal close-packed structure.

7. The magnetic recording medium according to claim 1, wherein at least one layer of said magnetic recording layer adopts a granular structure composed of ferromagnetic crystal grains and crystal grain boundaries of a non-magnetic oxide.

8. The magnetic recording medium according to claim 1, wherein an average crystal grain size of said magnetic recording layer is within a range from 1 to 7 nm.

9. A magnetic recording/reproducing device, comprising a magnetic recording medium and a magnetic head for recording and reproducing information on said magnetic recording medium, wherein said magnetic recording medium is a magnetic recording medium according to claim 1.
